(19) United States
(12) Patent Application Publication
(10) Pub. No.: US 2025/0203152 A1
(43) Pub. Date: Jun. 19, 2025

(54) TIMED METADATA FOR OVERLAYS

(71) Applicant: NBCUniversal Media, LLC, New York, NY (US)

(72) Inventors: Eric Manchester, Rockville, MD (US); Simon Rice, Bronxville, NY (US); David McLary, Upper Nyack, NY (US); Thomas Michael Rogers, Stamford, CT (US); Gian Constantine, Johns Creek, GA (US)

(21) Appl. No.: 18/538,615

(22) Filed: Dec. 13, 2023

(51) Int. Cl. H04N 21/431; H04N 21/84

(52) U.S. Cl. CPC H04N 21/4316; H04N 21/84

(57) ABSTRACT

A server-side content overlay system is provided to generate and trigger time-based content overlays during content playback. The content overlay playback is triggered by metadata provided from the server-side to the playback devices. The metadata includes the details useful for rendering the content overlays by the client playback systems.

### BACKGROUND

This disclosure relates generally to improved techniques for providing overlays in streamed content. More-specifically, techniques are provided for server-side overlay provision and/or triggering to a content playback client.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In recent years, content providers (e.g., streaming services) have that provided player overlays, images that appear on top of digital content, to provide additional information, such as advertisements and/or other featured information.

Video-on-demand (VOD) and live events (e.g., single live events (SLEs)) often incorporate image or visual overlays to enhance the viewer experience. Current solutions for providing overlays require full implementation of software development kits (SDKs) and complex overlay services to coordinate how the overlay graphics are managed and stored and then provided for display at the right time and position. The SDKs are integrated into the playback application, causing the playback application to be heavier in code, resulting in excessive client storage and processing requirements, which may limit playback abilities. For example, when activated, conventional overlay techniques relying on client-side processing may draw significant power and processing resources from the client device in order to implement overlays. Further, existing solutions also require that all possibly-used overlay libraries be loaded onto the playback application through the SDKs in order for the overlays to be inserted, which may further constrain client resources. Thus, a need exists to be able to insert overlays into content (e.g., VOD and live content) at scale with a reduced storage and processing footprint of the playback application, which results in increased efficiencies in power and processing loads on the client device.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In accordance with an embodiment of the present disclosure, a system, includes: a server-side editorial graphical user interface (GUI) that receives and stores overlay detail selections of a server-side-defined graphical overlay to be presented with requested content by a client-side content player; a data backplane that obtains service data from server-side services to incorporate into the server-side-defined graphical overlay based at least in part on the overlay detail selections; and an overlay metadata generator that: converts the raw overlay data comprising the overlay detail selections and the service data into overlay trigger code comprising metadata interpretable by the client-side content player to render the server-side defined graphical overlay.

In accordance with an embodiment of the present disclosure, a computer-implemented method includes: receiving, from a server-side service, overlay trigger code, comprising client-side content player instructions to generate a graphical overlay, wherein the contents of the graphical overlay are defined in the overlay trigger code; associating the overlay trigger code with content specified in the overlay trigger code; receiving a request for the content; and in response to receiving the request for the content: providing instruction to present the content in conjunction with the overlay trigger code, causing the client-side content player to present the content with the graphical overlay, in accordance with the overlay trigger code supplied by server-side service.

In accordance with an embodiment of the present disclosure, a tangible, non-transitory, computer-readable medium, include computer-readable instructions that, when executed by one or more processors of a computer, cause the computer to: request content for playback at the computer; in response the to the request, receive instructions for playing the content and a server-side-supplied overlay trigger code comprising metadata interpretable by the computer to render a server-side defined graphical overlay; playback the content in accordance with the instructions for playing the content; and render the server-side defined graphical overlay during the playback, in accordance with the overlay trigger code.

### BRIEF DESCRIPTION OF THE DRAWINGS

FIG. 1 is a diagram of an overlay system 100 that provides server-side specification and triggering of overlay presentation on a client-side 102 from a server-side 104 via triggering, via a Broadcast Operation Center (BOC) 105, a server-side content overlay service 106, in accordance with certain embodiments of the present technique;

FIG. 2 is flow chart, illustrating a process 200 for triggering/rendering server-side sourced overlays, in accordance with certain embodiments of the present technique;

FIG. 3 illustrates a live polling event implemented via an overlay system 100 and process 200 described above, in accordance with certain embodiments of the present technique; and

FIG. 4 illustrates an example flow 400 of switched streamed playback facilitated by server-side overlays, in accordance with certain embodiments of the present technique.

These and other features, aspects, and advantages of the present invention will become better understood when the following detailed description is read with reference to the accompanying drawings in which like characters represent like parts throughout the drawings, wherein:

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As noted above, there remains a need for improved overlay presentation with presentation of content. With this in mind, present embodiments are directed to improved overlay presentation techniques that provide server-side generated overlays that are timed to streamed content with frame and/millisecond accuracy, via provision of overlay metadata to playback clients playing the content.

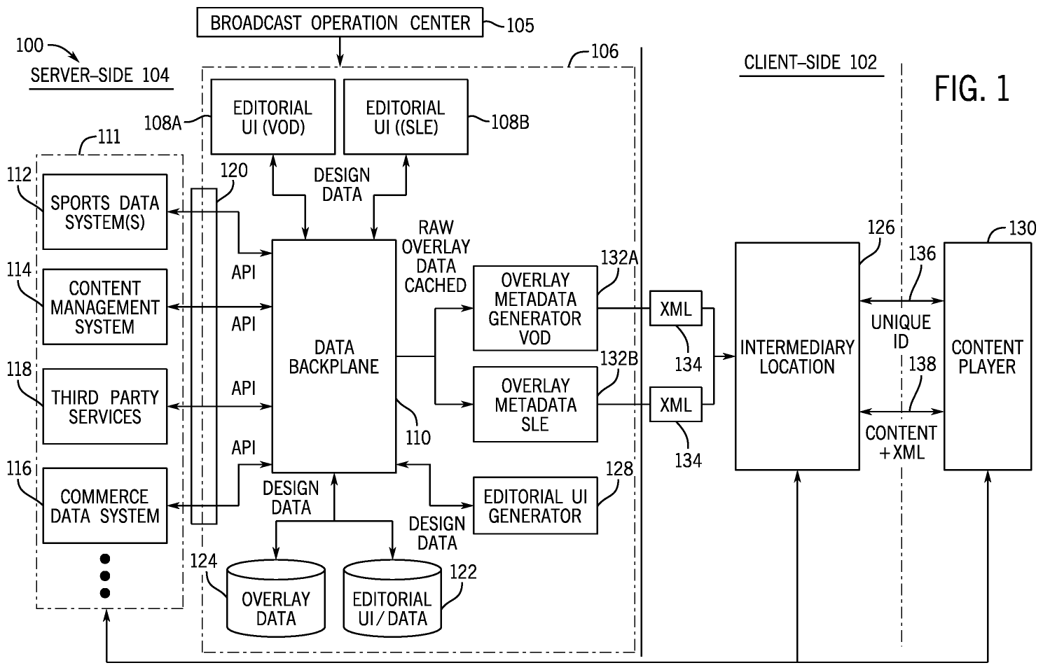

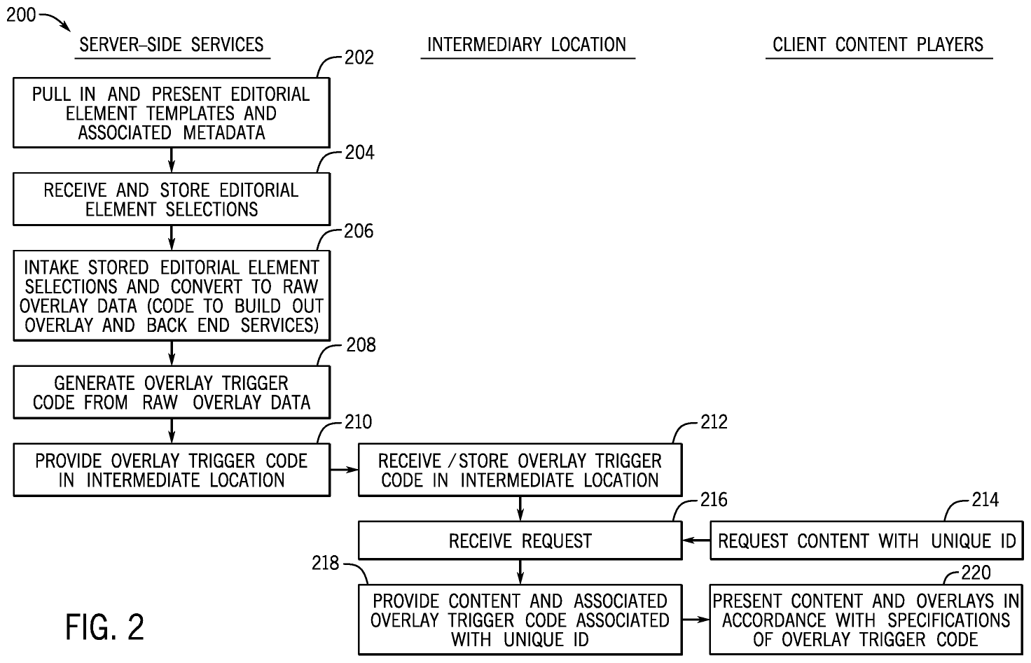

FIG. 1 is a diagram of an overlay system 100 that provides server-side specification and triggering of overlay presentation on a client-side 102 from a server-side 104 (e.g., via button actuation or other trigger at a Broadcast Operations Center 105 that provides the content for presentation by the content player 130) via a server-side content overlay service 106, in accordance with certain embodiments of the present technique. FIG. 2 is flow chart, illustrating a process 200 for triggering/rendering server-side sourced overlays. For simplicity, these figures will be discussed together.

As illustrated in FIG. 1, the editorial user interface (UI) 108A and 108B (collectively, “Editorial UI tool 108”) tool(s) are provided to allow an editor to select and create editorial elements and events (e.g., times and/or frames where overlays and/or other overlay-associated actions may be triggered and/or presented). The Editorial UI tool 108 may be the same for VOD or live event, or different Editorial UI tools (e.g., 108A and 108B) may be provided for each.

In the system, different types of editorial elements (e.g., overlays) may be provided. Some editorial elements are “static” and overlay the video playback without providing additional user interaction affordance. For example, a “heads up” overlay may provide a “Get Ready” indication, informing a viewer that an interactive overlay is coming. A countdown clock may provide a countdown to removal of an overlay, to rendering of a new overlay, etc. without providing an interaction affordance.

Some editorial elements are “interactive” and will allow the user to interact with the UI. In some use cases, data may be sent to a system that will cause new overlays (e.g., emojis) to appear on the user's client content player. Some editorial elements work with external services, such as polling, for example, which will allow the user to select an option (e.g., vote for your favorite contestant from the supplied selection affordances). The user's selection is sent to a back end service (e.g., a polling service) indicated in the Editorial UI tool 180 that may return additional data to present in the overlay (e.g., the current results of the poll). Determination of which editorial elements should be provided and when in the content the editorial elements should be provided may be set in the Editorial UI tool 108.

Certain editorial elements may have dependent relationships, enabling automatic timing of these editorial elements. For example, a “heads up” editorial element may be set to render five seconds prior to an interactive overlay and, thus, may be timed based upon the timing of the interactive overlay. Further, after an interaction occurs in the interactive overlay, a countdown editorial element may be set to instantly display, counting down to an end of the interactive overlay. In an aspect, the countdown editorial element may indicate a time duration that a user can interact with the interactive overlay. Because the timing is specified on the server-side, the timing may be set at frame-level and/or millisecond level accuracy.

The Editorial UI tool 108, via the data backplane 110, pulls in and presents editorial element templates, such as overlay and object templates, along with any associated metadata, that could be made available in a playback timeline of the content where an overlay and/or associated objects will be presented (block 202). Data to be presented in the overlay may be ingested from one or more supplemental data services 111 via the data backplane 110 from one or more local and/or third party locations. For example, data from multiple data services (e.g., sports data from Sports Data Systems(s) 112, data from a local Content Management System 114, shopping data from Commerce Data System 116, and/or data from other Third Party Services 118) may be ingested into a data backplane 110 for access by the Editorial UI tool 108 via one or more respective APIs 120 that allow communication between the data backplane 110 and each of the remote data sources. As will be discussed in more detail below, in some embodiments, the data to be presented from the one or more supplemental data services 111 may be pulled on the client-side 102, based upon instructions provided by the server-side content overlay service 106.

The Editorial UI may receive data from the Editorial UI Data Store 122, which may be a database containing all the information needed to generate the Editorial UI tool 108 interface for making overlay selections for particular content. For example, the Editorial UI Data Store 122 may include sets of overlay templates associated with different types of content. A desired template may be selected from a library of templates. Further, the template may be modified by selecting certain characteristics for use with the templates, such as images of components within the selected template, colors, fonts, etc.

The Editorial UI tool 108 may present particular template options, for example, based either on the type of overlay experience to be built or for a specific series and/or event. To provide one illustrative example, there may be a standard set of overlay templates built for most live events. However, special templates may be provided for use with content pertaining to the Olympics (e.g., a more event-specific template including the Olympics rings as part of the overlay graphics may be designed). The templates and supporting data (e.g., template images, such as the Olympics rings) are stored in the Editorial UI Data Store 122. When an Editor opens the Editorial UI tool 108, the Editor may select the type of UI needed (e.g., either generic or Olympics), resulting in the proper templates being retrieved for subsequent selection of details for editorial elements.

The Editor may use the Editorial UI tool 108 to select the detailed editorial element options (e.g., overlay options) that should appear, select the location of the editorial elements (e.g., overlay), and assign timing parameters defining the time (e.g., referential live playback times and/or frame numbers) when the editorial elements (e.g., overlay) should start and end. In an aspect, the location of certain editorial elements may be selected from a configuration template that predefines available locations for an overlay based on its size and shape.

Editorial element selections made via the Editorial UI tool 108 may be received and stored in the Overlay Data Store 124 (block 204). The selections represent the “design” and/or “editorial decisions” made in the Editorial UI tool 108. The Overlay Data Store 124 stores the data needed to properly generate the overlay specified by these design and/or editorial decisions.

Once the Overlay Data Store 124 is populated with detailed specification data of an overlay (e.g., the layout, editorial data, timing parameters, etc. have been defined and stored in the Overlay Data Store 124), the overlay may be prepared for presentation, by staging overlay generation data in a client-side 102 intermediary location 126 (e.g., CLIP) for playback via a client content player 130.

An Editorial UI Generator 128 intakes the data from the Editorial UI Data Store 122 and converts it into the code that may be used to build out the overlay and the back end services (e.g., calls to server-side 104 components, such as Third Party Services 118, etc. triggered via overlay selections made via the client content player 130), resulting in raw overlay data (block 206) that may be cached at an Overlay Metadata Generator 132 (e.g., a VOD-specific generator 132A, a Live-Event-specific generator 132B and/or a combined Metadata Generator 132 for both VOD and Live Events) that generates, at the server-side 104, overlay trigger code 134 (block 208).

To generate the overlay trigger code 134, the Overlay Metadata Generator 132 may convert the information from the cached raw overlay data supplied from the Overlay Data Store 124 into the overlay trigger code 134 (e.g., in the form of JSON and/or XML). Each overlay editorial element will be associated with timed metadata defining how and when an overlay will be inserted onto the underlying content. In certain embodiments, the timed metadata will identify a location of the overlay (e.g., an overlay URL) for retrieval by a client content player 130.

The code generated by the code generator will ultimately be consumed by the client content player 130 (e.g., a playback device or application controlling a video player), resulting in rendering of the overlay with the server-side specified details (e.g., layout, editorial data, timing, back end functionality, etc.) supplied in the overlay trigger code 134. In certain embodiments, the overlay trigger code 134 may be supplied to an intermediary location 126 (e.g., CLIP) (block 210) where it is stored (block 212). When the client content player 130 requests content, the client content player 130 may send a request for the content with a unique ID 136 associated with the content to an intermediary location 126 (block 214). The intermediary location 126 may receive the request (block 216) and provide a package 138 including the content associated with the unique ID 136 and the associated overlay trigger code 134 to the client content player 130 (block 218). The client content player 130 may then render the content with the overlays and overlay timings described by the overlay trigger code 134 (block 220). In some embodiments, the overlay trigger code 134 may be provided directly to the content player 130 independent of staging in an intermediary location 126.

The indication of the overlay trigger code 134 may be sent to the content player in a number of different manners. In some embodiments, a Society of Cable Telecommunications Engineers (SCTE), such as a Digital Program Insertion Cueing Message for Cable (SCTE-35) marker may be inserted in a content stream, indicating the overlay trigger code 134 and, thus, causing the client content player 130 to render an associated overlay. In some embodiments, the overlay trigger code 134 may be indicated by a metadata container associated with a supplied content stream, such as an ID3 tag associated with the content stream. In some embodiments, the overlay trigger code 134 may be indicated by a direct communication (e.g., an asynchronous call/asynchronous subscribed pipe) from the server-side content overlay service 106 to the client content player 130. In some embodiments, the client content player 130 may perform periodic polling of server-side content overlay service 106, requesting the overlay trigger code 134.

In certain embodiments, the client content player 130 may request content where the overlay elements and timings for the entire content may be known. For example, a VOD workflow may be pre-planned in the Editorial UI 108A indicating what overlays will be used and when the will show up in the asset. In such workflows, timing may be based on an asset starting time of 00:00:00 to the playtime length of the asset. Thus, overlays for VOD assets may be generated for the entire VOD asset prior to the request for the content. In such embodiments, the overlay trigger code 134 for all and/or multiple overlay elements may be consumed and/or read by the client content player 130 at one time. This may enable the client content player 130 to pre-cache the overlay elements for playback at the proper timings within the content playback by the client content player 130.

Changes via the Editorial UI 108A may be infrequent and may be based on basic updates from source data changes (e.g., from the server-side systems 112-118). Polling against these services for specific VOD assets may be set in the Editorial UI 108A, enabling polling refreshes of source data by the client content player 130 at specified intervals as well. So for example: Based upon selections in the Editorial UI 108A, the overlay trigger code 134 may instruct the client content player 130 to check for updates at intervals (e.g., every one day for the first 2 weeks then every month for the next 2 weeks and then every 6 months, etc.).

In some embodiments, at least a portion of the overlay elements may not be pre-known. This may particularly apply to live events, where there is limited lead time to generate overlay elements. For single live events (SLEs), the Editorial UI 108B may enable pre-building and on the fly building of editorial elements and their associated timings in the live content. SLE workflow timings may be based on NOW and real world times (e.g., a wall clock time). The Editorial UI 108B provides an interface that allows an editor to build an overlay on the fly and commit it “NOW” so that as soon as the client content player 130 reaches the time when the editor hit commit in its buffered playback, the overlay is rendered. The editor can prebuild a series of overlays and transmit them when desired. The Editorial UI 108B interface also provides affordances to enable the editor to provide an instruction to specify a delayed rendering of an overlay (e.g., “commit in X minutes” which would adjust rendering to the time when the option is selected is added to the specified delay). Upon receiving such an instruction in the overlay trigger code 134, the client content player 130 wait until its view is at the commit+delay time before rendering the overlay element.

In such embodiments, the overlay trigger code 134 for all overlay elements may not be sent to the client content player 130 with timing data. Instead each editorial event (or a subset of the editorial events) will be generated into separate overlay trigger code 134 (e.g., in JSON) and supplied for consumption by the client content player 130 at periodic or prescribed times and/or time intervals. The overlay trigger code 134 may contain timing data that instructs the client content player not to apply the overlay for a certain amount of time (e.g., X number of seconds).

The overlay trigger code 134 may provide overlay events of any type, format, and/or functionality of a specification supported by the content player 130. For example, the World Wide Web Consortium (W3C) has defined a specification to be followed for browser video element insertion. Specifically, the W3C's specification provides the ability to insert various overlay elements for media timed events. The overlay trigger code 134 may make use of this specification to instruct the content player 130 when and how to insert overlays during content playback.

Not all client content players 130 may support the same overlay functionalities. For example, client content players 130 running on relatively higher-powered devices may support certain features that relatively lower-powered may not, such as picture-in-picture functionality. The overlay trigger code 134 may be constructed in a manner that enables the content players 130 to render overlays in accordance with their own capabilities. In some embodiments, the content players 130 may simply ignore portions of the overlay trigger code 134 that they do not understand and/or that they cannot support. In some embodiments, the overlay trigger code 134 may target provide a plurality of versions of an overlay, one for each different level of functionality support (e.g., a “high” functionality overlay, a “medium” functionality overlay, and/or a “low” functionality overlay) and/or overlays specific to particular devices and/or standards supported by these devices. The content player 130 may select one of these overlays to render based upon their specific functionality support. In some embodiments, if the device type and/or supported functionality capabilities are known by the server-side content overlay service 106, the server-side content overlay service 106 may specifically select and provide a particular overlay to the content player 130 based upon the known device type and/or supported functionality capabilities.

The editor may also create a “queue” of pre-designed/edited overlays via the Editorial UI tool 108. The queue may include specified editorial/overlay elements and associated preset times when the editorial/overlay elements should be rendered. In some embodiments, the queue may specify a repeating interval for certain editorial/overlay elements (e.g., repeat overlay X every 10 minutes). In some embodiments, the queue may be used to build a pool of editorial/overlay elements, enabling the editor to quickly select a subset from the pool for rapid commitment of the selected subset of editorial/overlay elements.

In some embodiments, editorial elements may be generated without detail selections from the editor within the Editorial UI tool 108. For example, the overlay trigger code 134 may include code that triggers repetitive overlays to be rendered at periodic intervals and/or for specific durations of time. In one example, the overlay trigger code 134 may include instructions for the client content player 130 to display a banner type overlay with particular overlay details for a duration of 10 seconds 20 times. The banner type overlays may dynamically change, as the source data defining the editorial information within the overlay may change as the overlay is repeated.

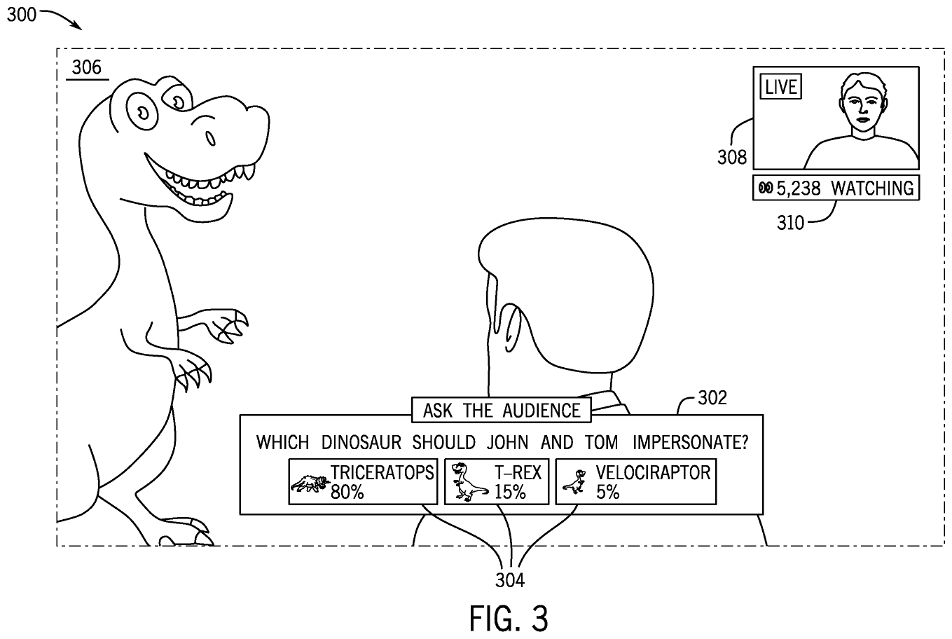

Depending on the instructions of the overlay trigger code 134, virtually any information may be provided “on the fly” (e.g., on the client-side 102). As indicated above, in some embodiments, one or more supplemental data services 111 may provide data to be presented in the overlays. The overlay trigger code 134 may provide an indication of particular supplemental data services 111 (e.g., via a URL) indicating where to obtain data that is to be used/presented in an overlay indicated by the overlay trigger code 134. Additionally and/or alternatively, the overlay trigger code 134 may indicate one or more supplemental data services 111 to access as a result of selections in an overlay. For example, in an interactive voting overlay, a selection of a particular choice may be associated with a particular URL of a voting supplemental data service that causes a vote for the selection to be counted. Having discussed how server-side overlays are generated for client-side presentation via the client content player 130, the discussion turns to particular exemplary use cases. FIG. 3 illustrates an example view 300 of a live polling event implemented via an overlay system 100 and process 200 described above, in accordance with certain embodiments of the present technique.

In the example view 300, several editorial elements (e.g., overlays) are presented via the client content player 130. For example, interactive overlay 302 provides interactive options 304, enabling a viewer to interact with the content 306. For example, the interactive overlay 302 is a polling overlay, where the interactive options 304 are poll responses that the viewer may select from. As mentioned above, the server-side generated overlay trigger code 134 that is provided to client-side may include code for accessing back end services (e.g., polling services) that facilitate some or all of the interactive functionality provided via selection of the interactive options 304. In the current example, as polling responses are received from viewers, a percentage of responses corresponding to a particular option 304 is rendered dynamically with the option. For example, 80% of viewers that have responded have selected “Triceratops.” Upon completion of the polling interval, the polling responses for the viewers may be counted and additional interactions may be triggered. For example, here, a top overlay 308 provides live content associated with the aggregated polling responses. For example, here a live view of the actor impersonating a triceratops may be shown, in response to the actor receiving the polling response breakdown indicating that the triceratops option was the most selected option. A non-interactive editorial element/overlay 310 is also provided. The overlay 310 provides a number of viewers of the content 306 without providing interactive options to the viewer.

The overlays 302, 308, and/or 310 may be generated from overlay templates selected from a template library, where particular details to use with the templates may be selected by the editor/designer. For example, the designer may select one or more images for use with the template, resulting in customized editorial elements that have a personalized look and/or feel, while still building from a common base template. The template's features and/or specified customization details may include, for example, background rendering details, such as a specification to use semi-transparent black. The background may include particular text or “copy” to be provided by the editorial element.

The template may include a top form specification that provides a general size and/or shape of the editorial element (e.g., a small black “pill” shaped overlay for overlay 302). The overlay 302 can support copy generated by the editor. The size, number of characters in that component, and if that component has an image associated with it may be determined by the template designer.

The template may specify a particular number of interface options that will be supported. For example, the template designer may design a template with 1, 2, 3, or more buttons, etc. In the illustrated example, overlay 302 includes 3 “pills”. Thus, this template supports the definition of three buttons and associated actions, while other templates may support a different number of buttons. Each button can have its size, shape, colors, copy, data presented, initial, roll over, clicked and images (e.g., as defined by the template designer).

Each button is connected to a single call to a back end service/action (e.g., a polling service). When selected, the button causes its selection value to be posted to the back end service (e.g., the polling service). The back end service may respond with the values of all three options.

The overlay trigger code associated with the template layout may describe buttons in any pre-defined X/Y location. The overlay trigger code contains an indication/definition of rules regarding button position, button horizontal and/or vertical orientation, button color choice, button images to be pulled in from outside applications, button effects (e.g., color changes) for particular actions (e.g., start, rollover, selected), button shapes, and/or other button properties. Further, an individual call (e.g., a different GET or POST or other form of call) to one or more back end services is selected for each button.

All selected properties can be controlled/described by a single overlay trigger code (e.g., a single XML file). The overlay trigger code contains all overlay properties. It also includes timing for when the player should start and stop rendering an overlay. As mentioned above, times for VOD content may be represented with respect to VOD timecodes, VOD time from a start of content, etc. For live (SLE) content, times may be represented with respect to “Now” (e.g., commit as soon as possible), a time since start of the live content, a reference time (e.g., “wall clock time”), etc.

Although the template used to generate the overlay 302 in FIG. 3 has components defined a certain way, editors can use the same template for different views. For example, the buttons can drive different calls depending on details selected by the editor that are provided in the overlay trigger code. Notably, because the overlays are defined on the server-side and supplied to the client-side, the client content players 130 need not be altered with additional code to render these overlays. The same basic code can be utilized, as the dynamic customizations that result in unique overlays are parameters provided from the server-side.

Templates that are developed can be stored and used for another event such as another VOD and/or live event. Over time the template library may grow, giving editors additional base template options, enabling fast generate of highly customized overlays, all without requiring client-side content player updates/changes.

In some embodiments, generative artificial intelligence (AI) may be used as an editor to identify and generate overlay trigger code 134 for generative AI defined overlays that may be desirable for particular targets, such as particular viewers, groups of viewers, particular content, etc. Generative AI may identify content corresponding to the particular target and define desirable overlays using this content. In one example, generative AI may identify a character present in a scene (e.g., set of frames) of content. The generative AI may generate overlay trigger code for the scene that defines an overlay that provides an option for a viewer of the scene to obtain more content relating to the character. For example, the generative AI may provide an action element for the overlay that, in response to a viewer indication of character interest, provides supplemental content, such as a timeline, previous clips, etc. illustrating a progression and/or important moments of the character that have occurred thus far.

To generate the overlay trigger code 134, the generative AI may receive inputs defining variables of interest with respect to the particular target. For example, with respect to particular viewers and/or groups of viewers, demographic information, viewing history information, etc. may indicate to the generative AI particular desirable overlays for these viewers and/or groups of users. With respect to particular content, character information, important scenes, scene subject matter, and/or other metadata with respect to the content may indicate desirable overlays for the content. The generative AI may make use of the one or more supplemental data services 111 for populating overlays and/or for generating resultant actions for overlay prompts. For example, a content management system 114 may provide a list of characters in a scene, enabling the generative AI to discern and generate overlay trigger code 134 that defines one or more overlays that prompts whether the viewer would like more information about the one or more characters present in the scene. The generative AI may also generate action content that is provided in response to affirmation that the viewer would like more information. For example, the generative AI may access the content management system 114 to identify other scenes the character is in, other interesting information about the character, etc. and aggregate this information into a content page and/or additional overlay that is triggered for rendering in response to the affirmation.

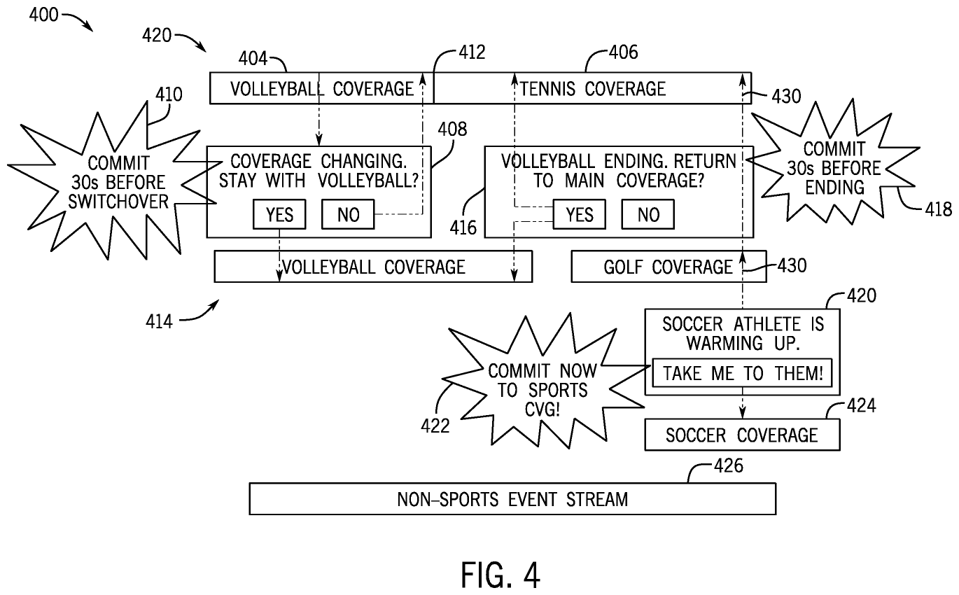

By simplifying overlay presentation, additional features may be enabled. For example, the editor may target particular users and/or a group of users with timed editorial elements. FIG. 4 illustrates an example flow 400 of timed editorial elements and some of interesting new capabilities that may be performed via the techniques described herein. FIG. 4 illustrates an example of multi-stream Olympics Coverage by a broadcaster. A primary stream 402 provides coverage of multiple events (e.g. Volleyball Coverage 404 that transitions to Tennis Coverage 406).

Using the server-side overlay techniques described herein, an editor may generate a server-side defined overlay 408 that is timed 410 to commit 30 seconds prior to switchover 412 to Tennis Coverage 406. As mentioned above, the details enabling the client content player 130 to render the overlay are provided in overlay trigger code generated on the server-side and provided to the client content player 130.

As illustrated, the overlay 408 is an interactive overlay that prompts whether the viewer wants to continue watching volleyball. If an interactive selection of the overlay 408 indicates that the viewer wants to continue watching volleyball, a back end service action defined in the overlay trigger code may cause the client content player 130 to switch from playing the primary stream 402 to an alternative stream 414 that continues providing volleyball coverage. Otherwise, if the viewer indicates that they would not like to continue watching volleyball, the client content player 130 maintains display of the primary stream 402.

An editor of the alternative stream 414 and/or the primary stream 402 may also generate an overlay for the alternative stream 414. For example, as the volleyball coverage ends at the alternative stream, the editor(s) may generate a second overlay 416 timed 418 to render 30 seconds prior to the end of the alternative stream 414, prompting whether the viewer would like to return to the primary stream 402. If the viewer's interactive response indicates to return to the primary stream 402, the back end call associated with that button is called by the client content player 130, causing playback of the primary stream. Otherwise, playback remains on the alternative stream 414 (e.g., by not performing a call based upon no action being assigned to this button).

In some embodiments, the editors may target overlays to particular individuals and/or groups of viewers. For example, overlays may be assigned to one group of users and a different set of overlays may be assigned to a second group of users (e.g., based on a group ID, content being watched, subject matter of content, content titles, and/or other condition). The criteria for the assignment may be noted in the overlay trigger code, resulting in client content players only rendering assigned overlays and ignoring any other provided overlays. In some embodiments, the assigned overlays may have different durations and/or timings based on user, user group identity, etc.

In the illustrated example of FIG. 4, an Olympics editor desires to commit an overlay 420 targeted/assigned to all Sports Coverage NOW, as indicated by timing 422. The overlay 420 is triggered to ask whether the viewers would like to switch to a key event occurring now on the soccer coverage stream 424. The overlay 420 is targeted to sports coverage viewers, so the overlay is not rendered with respect to the non-sports event stream 426. However, the overlay 420 is rendered in the golf coverage 428 and the Tennis Coverage 406, as indicated by dashed arrows 430. To do this, the overlay trigger code may be associated with each content that is sports coverage (based upon the instruction in the timing 422) and not with content that is not sports coverage. In this manner, when the client content player 130 requests and/or plays the associated content stream, the returned package of content and overlay trigger code will include the overlay 420 details, resulting in client-side rendering of the overlay 420. Upon a viewer's interactive selection that indicates that the view would like to view the key event, the client content player 130 may invoke a back end service call associated with the button, causing the client content player to switch to the soccer coverage stream 424.

Dynamic server-side overlays may be used for a number of different applications. For example, the overlays may also be used to enable a shopping experience. To do this, an editorial element may be generated and timed to content with a temporal location. The associated overlay trigger code is provided from the server-side to the client-side content player for implementation. Upon reaching the temporal location of the shopping editorial element within the content, the client content player 130 may render the shopping editorial element, indicating to the viewer that a shopping interaction is available. The shopping editorial element may be targeted, such that only a particular group of viewers potentially interested in the shopping interaction would be able to see the shopping editorial element. The shopping editorial element may also have a temporal feature such that it only appears for a predetermined time duration.

The technical effects of the present disclosure include a server-side content overlay service that generates and provides content overlays to client devices playing content. The server-side content overlay service may provide, via overlay metadata, to a client, details useful for rendering of the overlay at specific times during playback of the content (e.g., with frame-level and/or millisecond-level accuracy). By implementing generation and triggering of overlay rendering on the server-side, traditional client-side storage and processing constraints are reduced, resulting in more efficiency (e.g., freed up storage, reduced use of processing resources, and/or increased battery life) of client devices.

While only certain features of the invention have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform) ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a server-side editorial graphical user interface (GUI), configured to receive and store overlay detail selections of a server-side defined graphical overlay to be presented with requested content by a client-side content player;
a data backplane, configured to obtain service data from server-side services to incorporate into the server-side defined graphical overlay based at least in part on the overlay detail selections; and
an overlay metadata generator configured to:
convert raw overlay data comprising the overlay detail selections and the service data into overlay trigger code comprising metadata interpretable by the client-side content player to render the server-side defined graphical overlay.

2. The system of claim 1, comprising:
an editorial UI generator configured to:
generate a back end service call to associate with the server-side-defined graphical overlay, based upon at least a portion of the overlay detail selections; and
provide the back end service call to the overlay metadata generator as a portion of the raw overlay data to incorporate into the overlay trigger code.

3. The system of claim 2, wherein the back end service call comprises a call to a back end polling service that facilitates polling via an overlay selection option provided via the server-side-defined graphical overlay.

4. The system of claim 2, wherein the back end service call comprises a GET request, a POST request or both to the back end service.

5. The system of claim 1, wherein the overlay trigger code comprises a JavaScript Object Notation (JSON) file, an Extensible Markup Language (XML) file, or both.

6. The system of claim 1, wherein the overlay trigger code comprises a timing with respect to the requested content indicating when with respect to the requested content the server-side-defined graphical overlay should be presented with the requested content.

7. The system of claim 6, wherein the timing comprises an indication of a frame of the requested content where the server-side-defined graphical overlay should be presented.

8. The system of claim 6, wherein the timing comprises an indication of a duration of time that the server-side-defined graphical overlay should be displayed.

9. The system of claim 1, wherein the overlay metadata generator is configured to provide a plurality of overlay definitions in the overlay trigger code, enabling the client-side content player to pre-load a plurality of overlays associated with the plurality of overlay definitions.

10. The system of claim 1, wherein the overlay detail selections comprise a targeting indication to target the server-side-defined graphical overlay to a first subset of client-side content viewers without targeting a second subset of client-side content viewers; and wherein the overlay metadata generator is configured to cause the server-side-defined graphical overlay defined in the overlay trigger code to be rendered by the first subset of client-side content views but not the second subset of client-side content viewers.

11. The system of claim 10, wherein the targeting indication is based upon a particular subject matter of content playing on the first subset of client-side content viewers, a demographic of viewers of the first subset of client-side content viewers, or both.

12. A computer-implemented method, comprising:
receiving, from a server-side service, overlay trigger code, comprising client-side content player instructions instructing a client-side content player to render a graphical overlay, wherein contents of the graphical overlay are defined in the overlay trigger code;
associating the overlay trigger code with content specified in the overlay trigger code;
receiving a request for the content; and
in response to receiving the request for the content:
providing instruction to present the content in conjunction with the overlay trigger code, causing the client-side content player to present the content with the graphical overlay, in accordance with the overlay trigger code supplied by server-side service.

13. The computer-implemented method of claim 12, wherein the overlay trigger code comprises client-side content player instructions to generate an additional graphical overlay timed with respect to the graphical overlay, the additional graphical overlay configured to alert a viewer that the graphical overlay will be subsequently rendered.

14. The computer-implemented method of claim 12, wherein the overlay trigger code comprises client-side content player instructions to generate an additional graphical overlay timed with respect to the graphical overlay, the additional graphical overlay configured to alert a viewer of when the graphical overlay will cease rendering.

15. A tangible, non-transitory, computer-readable medium, comprising computer-readable instructions that, when executed by one or more processors of a computer, cause the computer to:
request content for playback at the computer;
in response to the request, receive instructions for playing the content and a server-side-supplied overlay trigger code comprising metadata interpretable by the computer to render a server-side defined graphical overlay;
playback the content in accordance with the instructions for playing the content; and
render the server-side defined graphical overlay during the playback, in accordance with the overlay trigger code.

16. The tangible, non-transitory, computer-readable medium of claim 15, comprising computer-readable instructions, that when executed by the one or more processors of the computer, cause the computer to:
receive a selection of a button within the rendered server-side defined graphical overlay;
in response to receiving the selection:
identify a back end service call associated with the button in the overlay trigger code; and
invoke the identified back end service call.

17. The tangible, non-transitory, computer-readable medium of claim 16, wherein the back end service call is to a polling service configured to aggregate a count of selection of supplied options in the server-side defined graphical overlay.

18. The tangible, non-transitory, computer-readable medium of claim 16, wherein the back end service call, when executed by the one or more computer processors, cause the computer to switch to playing a second content instead of playing the content.

19. The tangible, non-transitory, computer-readable medium of claim 15, comprising computer-readable instructions, that when executed by the one or more processors of the computer, cause the computer to:
render the server-side defined graphical overlay during the playback at a timing specified by the overlay trigger code.

20. The tangible, non-transitory, computer-readable medium of claim 19, wherein the timing is frame-timing specific, millimeter-timing specific, or both.
